(19) United States
(12) Patent Application Publication
(10) Pub. No.: US 2025/0102805 A1
(43) Pub. Date: Mar. 27, 2025

(54) ELECTRONIC DEVICE

(71) Applicant: Apple Inc., Cupertino, CA (US)

(72) Inventors: Brian S. Lau, Sacramento, CA (US); Michael J. Oudenhoven, San Francisco, CA (US)

(21) Appl. No.: 18/811,401

(22) Filed: Aug. 21, 2024

Related U.S. Application Data
(60) Provisional application No. 63/585,582, filed on Sep. 26, 2023.

(51) Int. Cl. G02B 27/01; F21V 8/00; G02B 27/18

(52) U.S. Cl. CPC G02B 27/0172; G02B 6/0013; G02B 6/0033; G02B 6/0075; G02B 6/0086; G02B 27/18; G02B 2027/0123; G02B 2027/0138; G02B 2027/0178

(57) ABSTRACT

A head-mountable electronic device can include a frame, a first display window attached to the frame, a second display window attached to the frame, a first waveguide associated with the first display window, a second waveguide associated with the second display window, a first arm connected to the frame, the first arm including a first projector to emit light into the first waveguide, the first projector pivotable relative to the first waveguide, and a second arm connected to the frame, the second arm including a second projector to emit light into the second waveguide, the second projector pivotable relative to the second waveguide.

### CROSS-REFERENCE TO RELATED APPLICATION(S)

This application claims the benefit of U.S. Provisional Patent Application No. 63/585,582, filed 26 Sep. 2023, and entitled “ELECTRONIC GLASSES,” the entire disclosure of which is hereby incorporated by reference.

### FIELD

The described embodiments relate generally to electronic eyewear. More particularly, the present embodiments relate to electronic head mountable devices having a hinge-forward design that allows for repeatable and reliable optical alignment.

### BACKGROUND

Electronic eyewear, such as head mountable devices (HMDs), computer glasses, or smart glasses are worn on a user's head and incorporate optical displays and computing capabilities. With the advent of HMDs comes an increased demand for small and stylish form factors. Binocular-display systems in electronic devices can include two displays that are aligned relative to each other with a very high precision. A misalignment of the displays can lead to a range of issues, such as eye strain, discomfort, and even total inability to merge the two images. Thus, a need exists for reliable alignment of the displays while maintaining a suitable form factor.

### SUMMARY

According to some aspects of the present disclosure, a head-mountable electronic device can include a frame, a first display window attached to the frame, a second display window attached to the frame, a first waveguide associated with the first display window, a second waveguide associated with the second display window; a first arm connected to the frame, the first arm including a first projector to emit light into the first waveguide, the first projector pivotable relative to the first waveguide, and a second arm connected to the frame, the second arm including a second projector to emit light into the second waveguide, the second projector pivotable relative to the second waveguide.

In some examples, the head-mountable electronic device can include an optical sensor disposed in the frame. Each of the first waveguide and the second waveguide can include an input coupler, a first output coupler to direct light to an eye of a user, and a second output coupler to direct light to the optical sensor. The head-mountable electronic device can include an optical sensor disposed in the frame to receive light from the first projector through the first waveguide and the second projector through the second waveguide and to detect an alignment between the first projector and the second projector. The head-mountable electronic device can include a third waveguide positioned in the frame between the first waveguide and the second waveguide, the third waveguide can direct light from the first projector and the second projector to the optical sensor.

In some examples, the head-mountable electronic device can include a first optical sensor disposed in the frame to detect light from the first waveguide, and a second optical sensor disposed in the frame to detect light from the second waveguide. The first projector can include an active field-of-view region emitting light from a projection panel, and the first projector can include an expanded field-of-view region that extends beyond the active projection panel. The active field-of-view region can be approximately 25 degrees. The expanded field-of-view region can be approximately 1.25 degrees. In some examples, the expanded field-of-view region can be more than 3 degrees greater than the active field-of-view region.

The head-mountable electronic device can include a first hinge pivotally connecting the first arm to the frame. The first hinge can be positioned between the frame and the first projector. The head-mountable electronic device can include a second hinge pivotally connecting the second arm to the frame. The second hinge can be positioned between the frame and the second projector.

According to some aspects, an electronic system can include a frame including an optical sensor, a display window including a waveguide connected to the frame, an arm including a light emitter connected the frame, and a hinge pivotally joining the frame and the light emitter, the hinge positioned between the frame and the light emitter. The optical sensor can detect an alignment between the light emitter and the waveguide.

In some examples, the hinge can include a cover to secure an optical path between the light emitter and the waveguide. The electronic system can include an attachment to releasably secure the arm in an open position. The light emitter can be movably suspended within the arm. The optical sensor can include a camera rigidly fixed to the frame. The display window can be a first display window, the waveguide can be a first waveguide, the arm can be a first arm, the light emitter can be a first light emitter, and the hinge can be a first hinge. The electronic eyewear further include a second display window including a second waveguide, a second arm including a second light emitter, and a second hinge pivotally joining the frame and the second light emitter, the second hinge positioned between the frame and the second light emitter. The optical sensor can detect an alignment between the first light emitter and the second light emitter. The optical sensor can detect an alignment between the first waveguide and the second waveguide.

According to some aspects, electronic glasses can include an arm structure defining an internal volume and an aperture, a light emitter disposed at least partially within the internal volume of the arm, the light emitter can include a first optical surface at the aperture, and a frame including a display window and a waveguide. The waveguide can define a second optical surface. When the arm structure is in a closed position, the first optical structure can be separated from the second optical surface, and when the arm structure is in an open position, the first optical surface can be adjacent to the second optical surface to define an optical path between the light emitter and the waveguide.

In some examples, the electronic glasses can include a sensor to detect whether the arm structure is in the open position or closed position. The electronic glasses can include an optical sensor disposed in the frame and optically aligned with the waveguide. An active field-of-view region can be electronically shifted within a projection panel in response to the optical sensor detecting a misalignment between the light emitter and the waveguide. The display window can be a first display window, and the waveguide can be a first waveguide. The frame can include a second display window and a second waveguide. The electronic glasses can further include an optical sensor disposed in the frame and optically aligned with the first display window and the second display window, wherein an active field-of-view region can be shifted within a projection panel in response to the optical sensor detecting a misalignment between the first display window and the second display window.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top view of electronic glasses in a closed configuration.

FIG. 1B shows a top view of the electronic glasses of FIG. 1A in an open configuration.

FIG. 2 shows a schematic diagram of a waveguide.

FIG. 3 shows a front view of display windows having waveguides.

FIG. 4A shows an aligned projector.

FIG. 4B shows a misaligned projector.

FIG. 4C shows an expanded projector field-of-view.

FIG. 4D shows a realigned projector on an expanded field-of-view.

FIG. 5 shows a hinge cover on electronic glasses.

FIG. 6 shows a process flow diagram of a calibration protocol.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a novel structure and alignment mechanism for electronic eyewear (i.e., electronic glasses or head-mountable electronic devices (HMDs)). Binocular-display systems in augmented reality (AR), virtual reality (VR) and mixed reality (MR) (collectively referred to as extended reality (XR)) devices can involve two displays that are aligned relative to each other with a very high precision (around) ˜0.1°. A misalignment of the displays can lead to a range of issues, such as eye strain/discomfort and even total inability to merge the two images.

Traditional or conventional XR display architectures are designed with a structurally rigid connection between the waveguides and the light emitters or projectors, with the projectors fixed to the frame of the device to maintain alignment between the projectors and the waveguides. In some devices, the projectors are mounted above the bridge of the frame, however, this leads to a product having a thick brow form factor, unlike typical glasses. In some devices, the projectors are mounted along a length of fixed arms. However, this arrangement can cause the hinge point to move back behind the projectors, which creates a non-typical and bulky design in the folded state.

Further, the rigid architecture employed by conventional devices relies on the assumption that the alignment between each waveguide and projector is fixed and changes minimally over the device's lifetime. This assumption can quickly break down and cause in-field failures that cannot be diagnosed without an active feedback loop of the alignment between the projectors and the waveguides. Thus, conventional architectures use an extremely rigid optical bench resulting in a higher product weight, increased size, and aesthetically unpleasing designs.

The present disclosure describes using an optical architecture that includes at least one sensor in the bridge or frame of electronic glasses that can directly measure the binocular boresight of the two displays relative to each other. The sensor(s) can be complemented by a projector having an oversized field-of-view (FoV) and capable of performing electronic image shifting to correct for detected misalignment. A bi-stable hinge mechanism can advantageously be positioned between the projector and the waveguide to produce a natural and typical glasses design in a closed configuration. Using the architecture described herein, the electronic glasses include a more natural and compact form factor.

In some examples, the waveguides include a first, main, or primary output coupler that out-couples the image to the user, and a secondary output coupler that out-couples the same image as the user's eye would see. The secondary output coupler is imaged by an optical sensor, such as a camera, and is used to calculate an alignment between the projector and the waveguide, or to calculate the alignment between a first display image and a second display image. For example, the optical sensor can calculate the display boresight.

In some examples, the hinge mechanism can include attachment features such as detents, magnets, protrusions, springs, latches, or any other mechanical features to secure the arms in a folded and unfolded state. In the unfolded state, such as when the user is wearing the glasses, the hinge mechanism can be capable of securing the position of the arm relative to the frame with high repeatability and with low angular variation. A variation from the nominal hinge position can be detected and measured by the optical sensor. Electronic image shifting can then be used to account for variations.

In some examples, the electronic glasses can include at least one projector having an oversized or expanded FoV. Once a misalignment is detected by the optical sensor, an oversized FoV can be used to realign the two displays relative to each other. For example, the projector can reserve additional FoV borders or regions around a nominal active area. In some examples, to achieve a nominal 25° (degrees)×25° (degrees) FoV, an additional ˜1.25° border can be reserved. Thus, in this case, the oversized or expanded projector can include a 27.5°×27.5° FoV. To re-align the two displays, the image can be electronically shifted to display within the projector's capable FoV. Thus, in this specific example, each display can be misaligned by ˜1.25° without cropping any of the image.

In this manner, electronic glasses using an optical bridge sensor in tandem with a robust and accurate hinge attachment system and oversized projector allows for a product desirable form factor product that can realign the displays each time the device is used. Further, the electronic classes advantageously include a hinge-forward design where the projectors are disposed behind the hinges, such that the hinges reside between the frame/waveguides and the projectors.

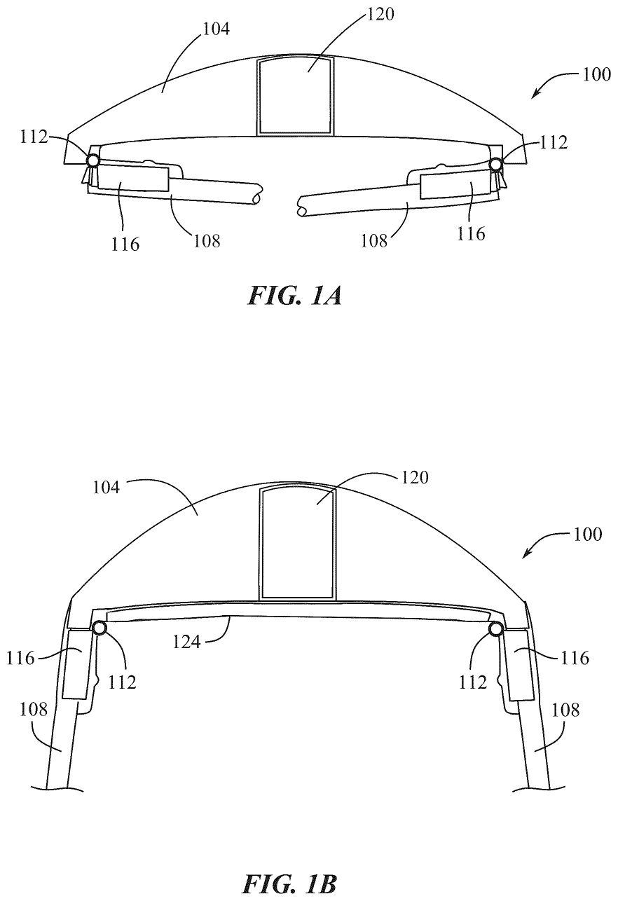

These and other embodiments are discussed below with reference to FIGS. 1A-6. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows a top view of electronic glasses 100 in a closed configuration. The electronic glasses 100 can include a frame 104 and arms 108 pivotally attached to the frame 104. The frame 104 can include a bridge that support or holds display windows. The frame 104 can include a housing that defines an internal volume. Electronic components can be disposed within the internal volume defined by the housing of the frame 104. In some examples, electronic components can be positioned on an exterior of the frame 104. As described in greater detail below, the frame 104 and/or display windows can include waveguides (not shown in FIGS. 1A and 1B).

In some examples, the frame 104 can include an optical sensor module 120. The optical sensor module 120 can include one or more optical sensors, such as cameras. The optical sensor module 120 can be disposed, partially or entirely, within the internal volume of the frame 104. In some examples, the optical sensor module 120 can define an exterior of the frame 104. The optical sensor module 120 can be mounted or secured to the frame 104 via a bracket. In some examples, the optical sensor module 120 can provide structural stability and support to the frame 104.

The electronic glasses 100 can include one or more arms 108. In the embodiment depicted in FIG. 1A, the electronic glasses 100 include two arms 108. The arms 108 can be support arms or support structures that are intended to rest above or on the user's ears to removably secure the electronic glasses 100 to the user's head.

The electronic device 100 can include multiple modes, states, or configurations. For example, the electronic glasses 100 can include a closed state in which the arms 108 are folded inward to be adjacent to and substantially parallel with the frame 104 (as depicted in FIG. 1A). FIG. 1B depicts the electronic glasses 100 in an open state in which the arms 108 are extended outward, substantially perpendicular to the frame 104. The arms 108 can be pivotally or rotationally joined at either end of the frame 104 via hinge mechanisms 112. The hinge mechanism 112 can be positioned between an end of the arm 108 and the frame 104. Thus, the arms 108 can pivot about the hinge mechanism 112 to transition between the closed state and the open state.

One or more of the arms 108 can include a light emitter or projector 116. In the embodiments described herein, each arm 108 comprises a projector 116. The projectors 116 generate and emit light producing images to be viewed by the user. The projectors 116 can be attached to the arms 108. In some examples, the projectors 116 are disposed within an internal volume of the arms 108. In some examples, the projectors 116 are mounted or attached on an exterior surface of the arms 108.

The projectors 116 can be rigidly fixed within or on the arms 108. In some examples, the projectors 116 can be movably secured to the arms 108. For example, the projectors 116 can be suspended or float within the arm 108 using springs or tensile wires, allowing for relative motion between the projectors 116 and the waveguides. This movement can enable the projectors 116 to move in order to properly couple with the waveguides when the arms 108 assume the open state. When in the open state, the projectors 116 can be locked or fixed in place. For example, the projectors 116 can include mating features that prevent motion of the projectors relative to the waveguides, once the arms 108 are in the open position.

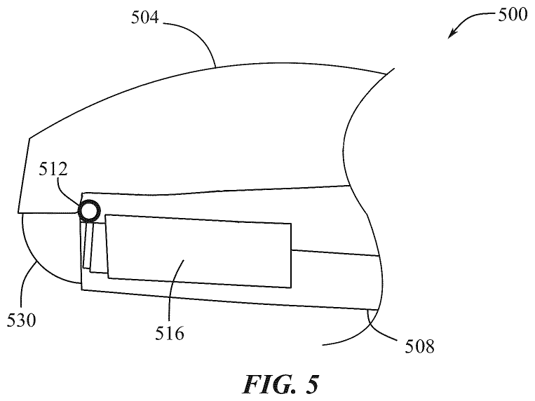

The projectors 116 can be positioned at an end of the arm 108. In some examples, the arms 108 can define an opening or aperture at the end of the arms 108. When in the closed state, the projectors 116 can be exposed to an outside environment. In some examples, an optical surface of the projectors 116 can define an exterior surface of the arm 108 and can be exposed through the open end of the arms 108. In some examples, when in the open state, the optical surfaces of the projectors 116 can be covered or not exposed to the outside environment. A further discussion of the optical surface and optical pathway of the projectors are provided below with reference to FIG. 5.

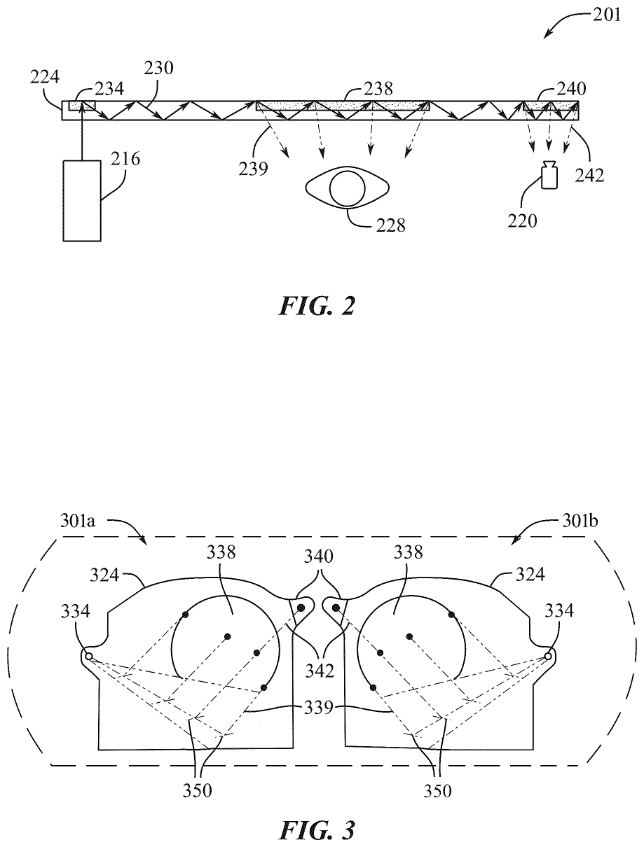

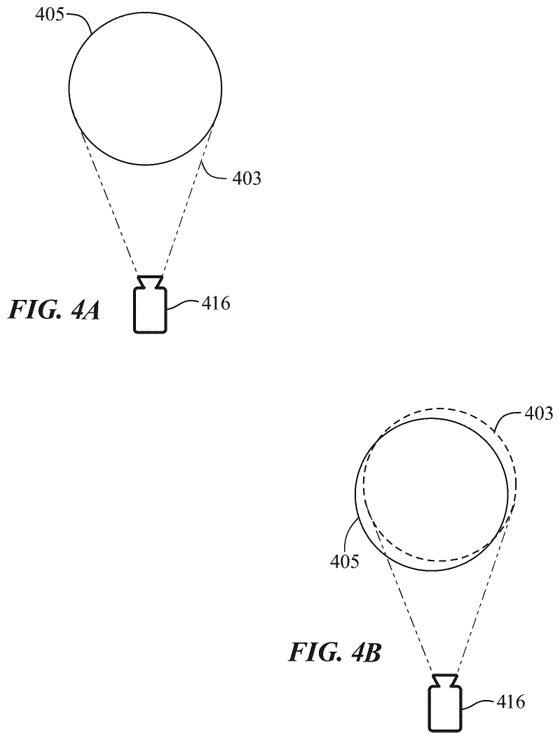

As shown in FIG. 1B, in the open state, the projectors 116 can be positioned immediately adjacent to the frame and to respective input couplers of the waveguides (see FIGS. 2 and 3 and corresponding discussion). In some examples, in the open position, an optical surfaces defined by the projectors 116 can directly contact or touch a corresponding optical surface of the input couplers. In some examples, in the open state, the projectors 116 can be positioned to establish an optical pathway between the projectors 116 and the waveguides (not shown in FIG. 1B). The electronic glasses 100 can include one or more sensors that can detect whether the arms 108 are in the open or closed state.

In some examples, to detect misalignment between the projectors 116, the electronic glasses 100 can include multiple optical sensors 120 that are aligned rigidly on the frame 104 of the electronic glasses 100. Advantageously, keeping optical sensors 120 rigidly fixed in position on the bridge is less of a challenge than rigidly fixing the entire bridge and projectors, as is done conventionally. In some examples, brackets can rigidly secure the optical sensors 120 in/on the bridge.

In some examples, the arms 108 and/or the frame 104 can include detents, magnets, mechanical features, kinematic mounts, or other features to enable secure, repeatable and consistent connection between optical surfaces when arms 108 are opened. Such attachment features could also enable proper securement for the arms 108 when in the open configuration, even in there is play between the arms 108 and the frame 104 in the closed configuration.

Any of the features, components, and/or parts, including the arrangements and configurations thereof shown in FIGS. 1A and 1B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A and 1B. Further, for simplicity, reference numbers ending in like or similar numbers, but with changes in the hundreds place may refer to the same or similar component from a different embodiment or figure.

FIG. 2 shows a top schematic diagram of a waveguide 201. The waveguide 201 can be substantially similar to, including some or all of the features of, the waveguides described herein. The waveguide 201 can be integrated into electronic glasses, such as electronic glasses 100. The waveguide 201 can be integrated into a 224. The waveguide 201 can include an input coupler 234, a first output coupler 238, and a second output coupler 240. The input coupler 234 can be positioned and constructed to receive light emitted from a projector 216. The input coupler 234 can direct received light 230 to the first output coupler 238 and the second output coupler 240.

The first output coupler 238 can be a main or primary output coupler that directs some of the light forming an image 239 to be viewed by an eye 228 of the user. A portion of the light 230 travels beyond the first output coupler 238 to the second output coupler 240. The second output coupler directs light forming an image 242 to an optical sensor 220. The image 239 presented to the eye 228 and the image 242 presented to the optical sensor 220 can be the same.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Further, for simplicity, reference numbers ending in like or similar numbers, but with changes in the hundreds place may refer to the same or similar component from a different embodiment or figure.

FIG. 3 shows a front view of a first waveguide 301a and a second waveguide 301b (collectively referred to as waveguides 301). The waveguides 301 can be substantially similar to, including some or all of the features of, the waveguides described herein, such as waveguide 201. Each of the waveguides 301 can be incorporated into or be defined by a display window 324. The waveguides 301 can each include an input coupler 334, a first output coupler 338, and a second output coupler 340. The input coupler 334 can be positioned and constructed to receive light emitted from a projector. The input coupler 334 can direct received light to the first output coupler 338 and the second output coupler 340.

The waveguides 301 can include SAG surface relief grating designed with an angle and shape to bounce and split light and allow a portion of the light to continue on. The waveguides 301 can include a plurality of gratings 350 to direct light 339 toward the first output coupler 338. The first output coupler 338 can be a main or primary output coupler that directs some of the light forming an image to be viewed by an eye of the user. A portion of the light 342 travels beyond the first output coupler 338 to the second output coupler 240. The second output coupler directs light forming an image to an optical sensor. The image presented to the eye from the first output coupler 338 and the image presented to the optical sensor from the second output coupler 340 can be the same.

In some examples, the electronic glasses can include a single optical sensor for imaging both second output couplers 340 from each of the waveguides 301. In the case of a single optical sensor monitoring both waveguides 301, there can be a third waveguide or intermediate waveguide (not shown) to direct the light from the waveguides 301 to the optical sensor.

In some examples, the waveguides 301 can produce image replication by taking a single image pupil from the projector and expanding it into multiple pupils toward output couplers 338, 340. Thus, from a single input image, multiple image pupils can be generated using the waveguides 301.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Further, for simplicity, reference numbers ending in like or similar numbers, but with changes in the hundreds place may refer to the same or similar component from a different embodiment or figure.

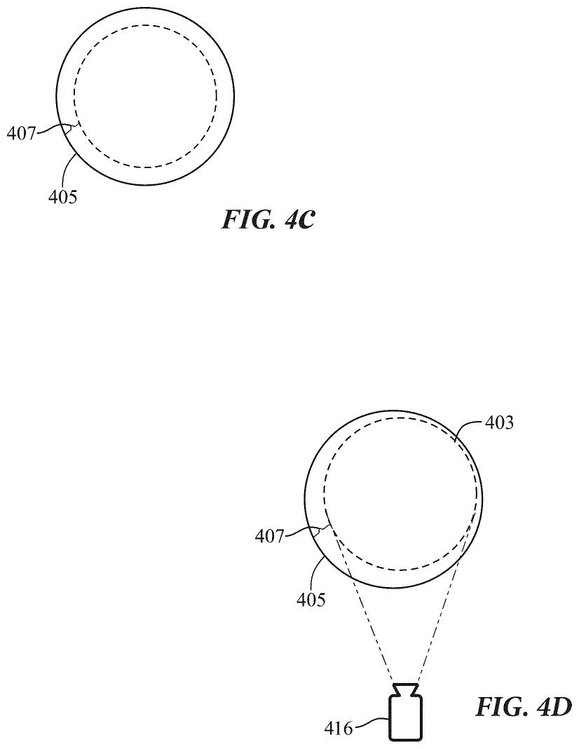

FIG. 4A shows a light emitter or projector 416 properly aligned with an imaging or projection panel 405. The projector 416 can be substantially similar to, including some or all of the features of, the projectors described herein, such as projectors 116, 216, and 316. For example, the projector 416 can be attached to an arm of electronic glasses. The projector 416 can be intended to project an image 403 having a field-of-view that is aligned with imaging or projection panel 405. The projection panel 405 can be an active area, such as a digital micro-mirror device (DMD chip). In some examples, the imagining panel 405 can be part of the projector 416. In other words, the “projector” can include a light source and a DMD chip. In some examples, the projection panel can include liquid crystal on silicon (LCOS), ultra light emitting diode (uLED), ultra-organic light emitting diode (uOLED), or any other suitable projection panel.

FIG. 4B shows an example misalignment between the projector 416 and the projection panel 405. In the context of the present disclosure, the misalignment can be a result of an arm of the electronic glasses being deformed or bent out of shape, resulting in the image 403 being off-center from the projection panel 405. Misalignment can also occur as a result of other factors, including, but in no way limited to, frame deformations, or deformations in the mechanical mounting of the display components. This is a specific challenge for electronic glasses having movable projectors relative to the waveguides.

FIG. 4C shows a projection panel 405, such as a DMD chip having an expanded area 407. As a solution to potential movement or shifting in the projector 416, the projection panel 405 can be oversized or expanded in order to allow for re-alignment. For example, FIG. 4D illustrates the “misaligned” projector 416 of FIG. 4B emitting light onto the oversized imagining panel 405, which due to the extended area 407 is still able to operate and display the image properly.

For example, the projection panel 405 can typically have a field-of-view (FoV) of about 25° of active area. In the present example, the projector can include an extra ˜1.25° of field-of-view around the active DMD panel 305. Thus, when shifts do occur, the projector 416 can shift where on the DMD panel 305 the image is being projected, and accordingly, what the eye sees is still aligned. In some examples, the expanded FoV region 307 can be expanded by between about 1° to 3°, by about 3° to 5°, or by about 8° to 10°. In other words, the projectors can include an active field-of-view region directed onto imaging projection panel, and an expanded field-of-view region that extends beyond the active projection panel.

Any of the features, components, and/or parts, including the arrangements and configurations thereof shown in FIGS. 4A-4C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4C. Further, for simplicity, reference numbers ending in like or similar numbers, but with changes in the hundreds place may refer to the same or similar component from a different embodiment or figure.

FIG. 5 shows a hinge cover 530 on electronic glasses 500. The electronic glasses 500 can be substantially similar to, including some or all of the features of, the electronic glasses described herein, such as electronic glasses 100, 200, and 300. The hinge cover 530 can be positioned between the frame 504 and the arm 508. The hinge cover 530 can move or articulate as the arm 508 transitions between an open state and a closed state. The hinge cover 530 can shield or secure an optical pathway between the projector 516 and the waveguide (not shown in FIG. 5). The hinge cover 530 can prevent ingress of dust or debris into the optical interface between the arm 508 and the frame 504.

In some examples, the hinge cover 530 can move as the arm 508 moves such that an opening or aperture is reveal in the hinge cover 530 to allow for passage of light when the end of the arm 508 is securely positioned against the frame 504, preventing ingress of debris between the arm 508 and the frame 504. As the arm 508 is moved to a closed state, the hinge cover 530 can move to occlude or block the gap formed between the end of the arm 508 and the frame 504.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Further, for simplicity, reference numbers ending in like or similar numbers, but with changes in the hundreds place may refer to the same or similar component from a different embodiment or figure.

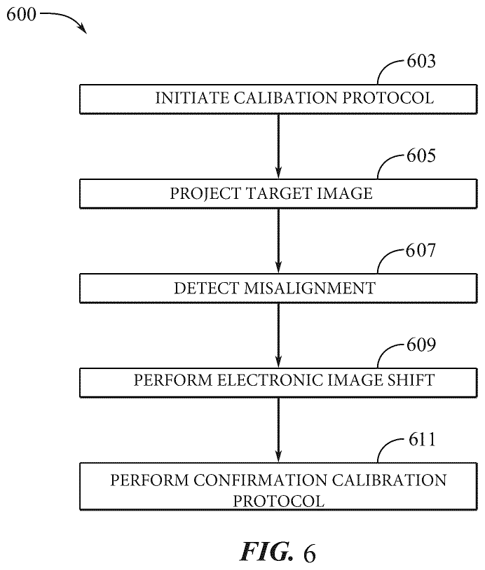

FIG. 6 illustrates a process flow diagram of an example operation of electronic glasses integrated with the components detailed herein. At step 603, a calibration protocol can be initiated. The calibration protocol can be performed to test the alignment of the projectors. The calibration protocol can be initiated or performed each time the electronic devices are turned on. In some examples, the calibration protocol can be performed in response to the arms being moved to the open state. In some examples, the calibration protocol can be triggered to begin in response to the electronic glasses being placed on a user's head. For example, depending of the size and shape of the user's head, the arms may be flexed outward when placed on the user's head (i.e., further outward than when simply in an open state, but not placed on the user's head). Thus, performing the calibration protocol in response to the arms being in the open state may not be sufficient to ensure that the projectors are properly aligned while the electronic glasses are being worn by the user. A solution can be to perform the calibration protocol in response to detecting (e.g., via a touch/pressure sensor) that the electronic devices are donned by the user. This ensures that any arm flex caused by the user's head is accounted for when performing the calibration protocol.

At step 605, a target or test image can be projected into the waveguide. The calibration protocol can include instructing the projectors to display a predetermined image or target that is sensed by the optical sensor(s). The position of the target images can be tested against a known location where the target images should be during proper alignment. At step 607, an alignment can be detected by the optical sensor(s). At step 609, upon detecting a misalignment, the calibration protocol can instruct one or more projectors to perform electronic image shifting in order to correct the misalignment. At step 611, realignment of the system can be tested by performing a confirmation calibration protocol. The confirmation calibration protocol can include performing steps 603 and 605 to confirm whether the realignment was successful or if additional correction is needed. The above is one example of a calibration protocol that can be performed using the components and structures (e.g., optical sensor(s) and oversized projector) as described herein.

In some examples, during the calibration protocol, each projector can be compared relative to the other projector. However, this method may not inform the system which projector is misaligned, but rather simply that the projectors are not aligned relative to each other. Thus, in some examples, an aligned test can be performed on each projector, independently, to isolate which projector is out of alignment.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A head-mountable electronic device, comprising:
a frame;
a first display window attached to the frame;
a second display window attached to the frame;
a first waveguide associated with the first display window;
a second waveguide associated with the second display window;
a first arm connected to the frame, the first arm comprising a first projector to emit light into the first waveguide, the first projector pivotable relative to the first waveguide; and
a second arm connected to the frame, the second arm comprising a second projector to emit light into the second waveguide, the second projector pivotable relative to the second waveguide.

2. The head-mountable electronic device of claim 1, further comprising an optical sensor disposed in the frame;
wherein each of the first waveguide and the second waveguide comprises:
an input coupler;
a first output coupler to direct light to an eye of a user; and
a second output coupler to direct light to the optical sensor.

3. The head-mountable electronic device of claim 1, further comprising an optical sensor disposed in the frame and configured to receive light from the first projector through the first waveguide and the second projector through the second waveguide and to detect an alignment between the first projector and the second projector.

4. The head-mountable electronic device of claim 3, further comprising a third waveguide positioned in the frame between the first waveguide and the second waveguide, the third waveguide configured to direct light from the first projector and the second projector to the optical sensor.

5. The head-mountable electronic device of claim 1, further comprising:
a first optical sensor disposed in the frame configured to detect light from the first waveguide; and
a second optical sensor disposed in the frame configured to detect light from the second waveguide.

6. The head-mountable electronic device of claim 1, wherein:
the first projector comprises an active field-of-view region emitting light from a projection panel; and
the first projector comprises an expanded field-of-view region that extends beyond the active field-of-view region.

7. The head-mountable electronic device of claim 6, wherein:
the active field-of-view region is approximately 25 degrees; and
the expanded field-of-view region is approximately 1.25 degrees.

8. The head-mountable electronic device of claim 6, wherein the expanded field-of-view region is more than 3 degrees greater than the active field-of-view region.

9. The head-mountable electronic device of claim 1, further comprising:
a first hinge pivotally connecting the first arm to the frame, the first hinge positioned between the frame and the first projector; and
a second hinge pivotally connecting the second arm to the frame, the second hinge positioned between the frame and the second projector.

10. An electronic system, comprising:
a frame comprising an optical sensor;
a display window comprising a waveguide connected to the frame;
an arm comprising a light emitter connected the frame; and
a hinge pivotally joining the frame and the light emitter, the hinge positioned between the frame and the light emitter;
wherein the optical sensor is configured to detect an alignment between the light emitter and the waveguide.

11. The electronic system of claim 10, wherein the hinge comprises a cover configured to secure an optical path between the light emitter and the waveguide.

12. The electronic system of claim 10, further comprising an attachment configured to releasably secure the arm in an open position.

13. The electronic system of claim 10, wherein the light emitter is movably suspended within the arm.

14. The electronic system of claim 10, wherein the optical sensor comprises a camera rigidly fixed to the frame.

15. The electronic system of claim 10, wherein the display window is a first display window, the waveguide is a first waveguide, the arm is a first arm, the light emitter is a first light emitter, and the hinge is a first hinge;
the electronic eyewear further comprising:
a second display window comprising a second waveguide;
a second arm comprising a second light emitter; and
a second hinge pivotally joining the frame and the second light emitter, the second hinge positioned between the frame and the second light emitter;
wherein the optical sensor is configured to detect an alignment between the first light emitter and the second light emitter.

16. The electronic system of claim 15, wherein the optical sensor is configured to detect an alignment between the first waveguide and the second waveguide.

17. Electronic glasses, comprising:
an arm structure defining an internal volume and an aperture;
a light emitter disposed at least partially within the internal volume of the arm, the light emitter comprising a first optical surface at the aperture; and
a frame comprising a display window and a waveguide, the waveguide defining a second optical surface;
wherein, when the arm structure is in a closed position, the first optical structure is separated from the second optical surface; and
wherein, when the arm structure is in an open position, the first optical surface is adjacent to the second optical surface to define an optical path between the light emitter and the waveguide.

18. The electronic glasses of claim 17, further comprising a sensor configured to detect whether the arm structure is in the open position or closed position.

19. The electronic glasses of claim 17, further comprising an optical sensor disposed in the frame and optically aligned with the waveguide;
wherein an active field-of-view region is shifted within a projection panel in response to the optical sensor detecting a misalignment between the light emitter and the waveguide.

20. The electronic glasses of claim 17, wherein the display window is a first display window, and the waveguide is a first waveguide, the frame comprising a second display window and a second waveguide;
the electronic glasses further comprising an optical sensor disposed in the frame and optically aligned with the first display window and the second display window, wherein an active field-of-view region is shifted within a projection panel in response to the optical sensor detecting a misalignment between the first display window and the second display window.
